(19) United States
(12) Patent Application Publication
(10) Pub. No.: US 2009/0135020 A1
(43) Pub. Date: May 28, 2009

(54) DETECTING DEVICE FOR DETECTING BARRIERS BEHIND DOOR

(75) Inventor: Yung-Tsung Hsiao, Nantou County (TW)

Correspondence Address: BROWDY AND NEIMARK, P.L.L.C.;624 NINTH STREET, NW, SUITE 300, WASHINGTON, DC, 20001-5303, US

(73) Assignee: UNIVERSAL SCIENTIFIC INDUSTRIAL CO., LTD., Tsao Tuen (TW)

(21) Appl. No.: 12/131,495

(22) Filed: Jun. 2, 2008

(30) Foreign Application Priority Data
Nov. 27, 2007 (TW) 96220059

(51) Int. Cl. G08B 21/02

(52) U.S. Cl. 340/686.1

(57) ABSTRACT

A detecting device for detecting barriers behind a door includes a sensor for transmitting detecting signals to detect whether there is a barrier behind the door, an identifier for transmitting identification signals to identify whether the barrier behind the door is a living animal, and an alarm electrically connected with the sensor and the identifier for generating an inductive signal according to a detecting result of the sensor or an identification result of the identifier. As a result, the detecting device can detect whether there is any barrier behind the door and whether the barrier is a living animal through the detecting signals of the sensor and the identification signals of the identifier. If a barrier is behind the door, the alarm will generate a warning signal to notify the person who is going to open the door such that the person can carefully open the door.

### BACKGROUND OF THE INVENTION

1. Field of the Invention

The present invention relates generally to a detecting device, and more specifically to a detecting device that can detect whether there are barriers behind a door.

2. Description of the Related Art

Recently, wooden floors or plastics floor mats are extensively used in home decoration. After cleaning the wooden floors or the plastics floor mats, family members can sit or lie down on them. Therefore, some parents may put their child on the wooden floors or the plastics floor mats and allow their child to crawl and play on them.

However, because of the negligence of the parents, the child may crawl to a place behind a door and then play over there. If somebody just opens the door at this moment, the child behind the door will be easily hurt by the opened door. Thus, the parents have to keep an eye on their child all the time for preventing the child from crawling to the place behind the door.

### SUMMARY OF THE INVENTION

The present invention has been accomplished in view of the above-noted circumstances. It is one objective of the present invention to provide a detecting device capable of detecting whether there are barriers behind a door.

It is another objective of the present invention to provide a detecting device capable of detecting whether there are living animal behind a door.

To achieve the above-mentioned objectives of the present invention, the detecting device comprises a sensor for transmitting detecting signals to detect whether there is a barrier behind a door, an identifier for transmitting identification signals to identify whether the barrier behind the door is a living animal, and an alarm electrically connected with the sensor and the identifier for generating an indicative signal according to a detecting result of the sensor or an identification result of the identifier.

In an exemplary embodiment, the sensor is an ultrasonic wave sensor that can transmit the detecting signals of ultrasonic wave to detect whether there are barriers behind the door, and the identifier is an infrared identifier that can transmit the identification signals of infrared rays to detect whether the barriers behind the door are living animals.

As a result, the detecting device can generate an indicative signal to notify the person who is going to open the door that a barrier is behind the door and the barrier behind the door is an object or a living animal, thereby avoiding the living animal from injury.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic drawing of the detecting device according to a preferred embodiment of the present invention, showing there is nothing behind the door;

FIG. 2 is an enlarged perspective view of the alarms of the detecting device according to the preferred embodiment of the present invention;

FIG. 3 is a schematic drawing of the detecting device according to the preferred embodiment of the present invention, showing there is an object behind the door;

FIG. 4 is similar to FIG. 2 but showing that the alarms are indicative of the status shown in FIG. 3;

FIG. 5 is a schematic drawing of the detecting device according to the preferred embodiment of the present invention, showing there is a living animal behind the door;

FIG. 6 is similar to FIG. 2 but showing that the alarms are indicative of the status shown in FIG. 5, and

FIG. 7 is a flowchart showing the operation of the detecting device according to the preferred embodiment of the present invention.

### DETAILED DESCRIPTION OF THE INVENTION

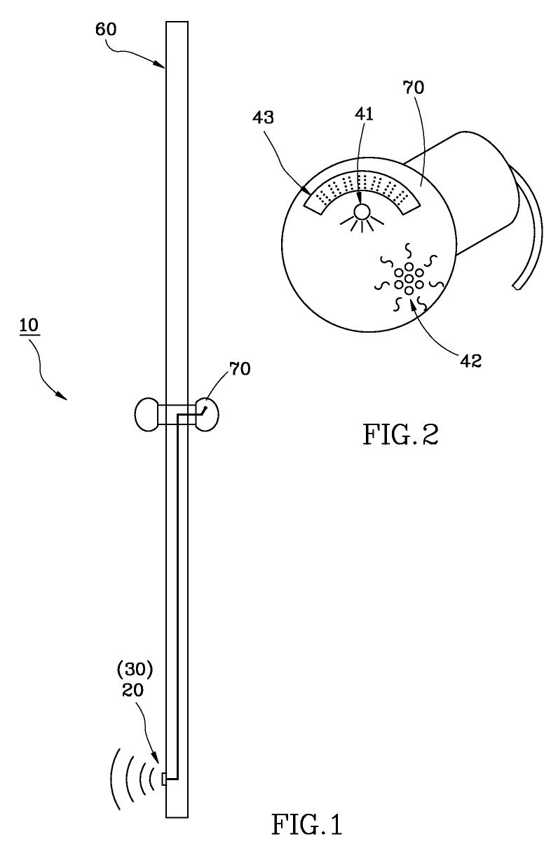

As shown in FIGS. 1 and 2, a detecting device 10 in accordance with a preferred embodiment of the present invention comprises a sensor 20, an identifier 30, and two alarms 41 and 42.

In this preferred embodiment, the sensor 20 is, but not limited to, an ultrasonic wave sensor, which is mounted to the back of a door 60. The sensor 20 has switching means embodied in a door handle 70 at the front of the door 60 and can transmit detecting signals in the form of ultrasonic wave to detect whether there are barriers behind the door 60 when the door handle 70 is turned to switch on the sensor 20.

The identifier 30 is, but not limited to, an infrared identifier, which is mounted to the back of the door 60. The identifier 30 has switching means embodied in the door handle 70 and can transmit identification signals in the form of infrared rays to detect whether the barriers behind the door 60 are living animal when the door handle 70 is turned to switch on the identifier 30.

The alarms 41 and 42 are fitted to the door handle 70 and electrically connected with the sensor 20 and the identifier 30 for receiving the detecting result of the sensor 20 and the identification result of the identifier 30 respectively so as to generate corresponding warning signals. In this embodiment, the alarm 41 is an LED lamp, which can generate a green light to show the detecting result of false indicative of that there is no barrier behind the door 60, and a red light to show the detecting result of true indicative of that there are barriers behind the door 60. The alarm 42 is a buzzer, which can generate one long beep representing the fact of that there is no barrier behind the door 60, a continuous beep representing the identification result of that there are barriers which are living animals behind the door 60, and three short beeps representing the identification result of that there are barriers which are objects behind the door 60.

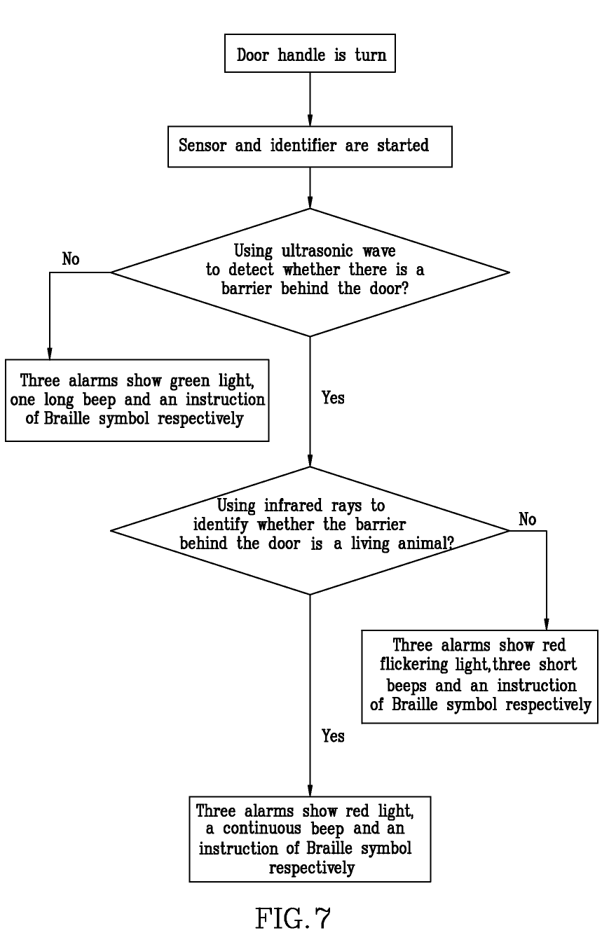

By means of the aforesaid design, when a door opener turns the door handle 70, the sensor 20 and the identifier 30 are started to respectively transmit the detecting signals and the identification signals. If detecting result of the sensor 20 shows that there is no barrier behind the door 60, as shown in FIG. 1 and FIG. 7, the alarm 41 will show the green light and the alarm 42 will generate a long beep, as shown in FIG. 2 and FIG. 7. In this situation, the door opener can open the door 60 without any worry.

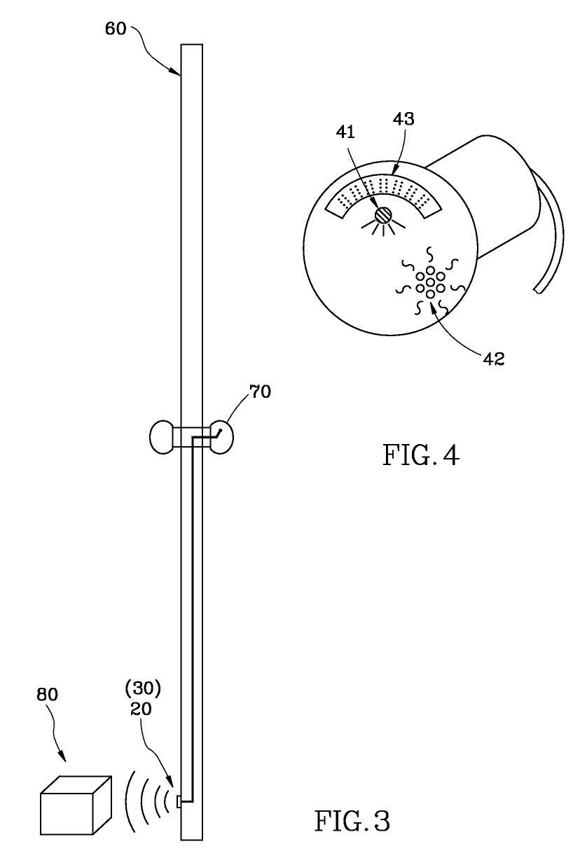

If a barrier 80 is placed behind the door 60 and the door handle 70 is turned, as shown in FIG. 3 and FIG. 7, the detecting signals generated by the sensor 20 will detect the existence of the barrier 80 and the identification signals generated by the identifier 30 will identify that the barrier is an object because the object produces no body heat energy. In this situation, the alarm 41 receiving the detecting result of true will show the red flickering light, and the alarm 42 receiving the identification result indicative of the existence of an object will generate three short beeps, as shown in FIG. 4 and FIG. 7, thereby reminding the door opener that there is an object behind the door 60 such that he/she should open the door slowly and carefully.

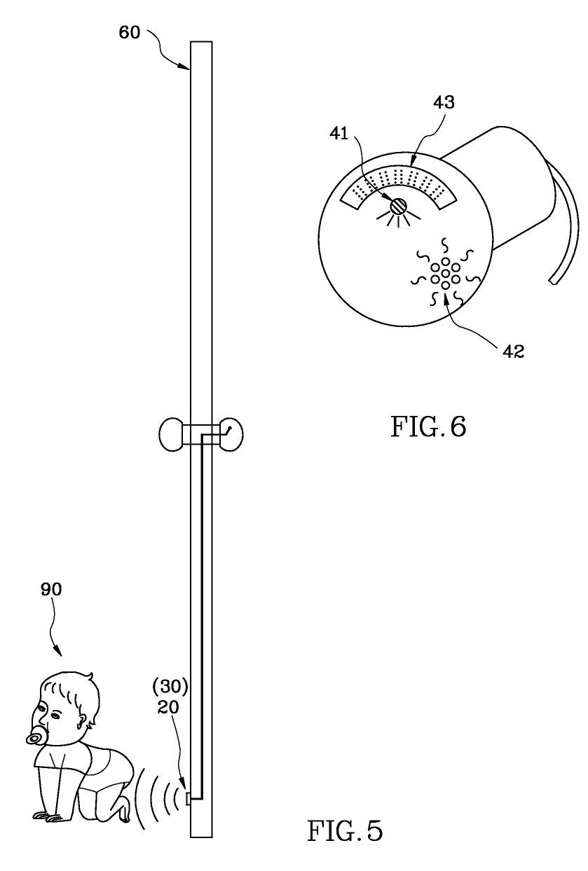

If the barrier 90 behind the door 60 is a living animal, for example a baby as shown in FIG. 5, the detecting signals generated by the sensor 20 will detect the existence of the barrier 90 and the identification signals generated by the identifier 30 will identify that the barrier is a living animal because of detection of the body heat energy generated by the barrier 90. In this situation, the alarm 41 will show the red light and the alarm 42 will generate a continuous beep to remind the door opener that there is a living animal behind the door 60, as shown in FIG. 6 and FIG. 7.

Referring to FIG. 2, the door handle 70 is further equipped with an alarm 43 having a Braille display. The alarm 43 also can receive the detecting result from the sensor 20 and the identification result from the identifier 30 and then display the aforesaid results by an instruction of Braille characters, thereby reminding the blind about the status behind the door 60.

Although the above-mentioned three alarms 41-43 are embodied in the door handle 70 in the preferred embodiment, it will be appreciated that this design is not a limitation to realize the present invention but just an example for illustrative purpose. For example, the light alarm or the sound alarm can be configured to the door handle selectively. Further, the alarms can be mounted on the door plate or a position near the door according to the actual condition. Naturally, the color of the light shown by the light alarm and the type of the sound generated by the sound alarm are also not limited to the above-mentioned disclosures in the preferred embodiment but can be designed with diversity according to the actual need.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A detecting device for detecting barriers behind a door, the detecting device comprising:
a sensor for transmitting detecting signals to detect whether there is a barrier behind the door;
an identifier for transmitting identification signals to identify whether the barrier behind the door is a living animal; and
an alarm electrically connected with the sensor and the identifier for generating an indicative signal according to a detecting result of the sensor or an identification result of the identifier.

2. The detecting device as claimed in claim 1, wherein the sensor is an ultrasonic wave sensor that transmits the detecting signals of ultrasonic wave

3. The detecting device as claimed in claim 1, wherein the identifier is an infrared identifier that transmits the identification signals of infrared rays.

4. The detecting device as claimed in claim 1, wherein the warning signal is in the form of light.

5. The detecting device as claimed in claim 1, wherein the warning signal is in the form of sound.

6. The detecting device as claimed in claim 1, wherein the warning signal is in the form of a Braille symbol.

7. The detecting device as claimed in claim 1, further comprising an additional alarm electrically connected with the sensor and the identifier for generating an additional indicative signal according to the detecting result of the sensor or the identification result of the identifier.
